(19) United States
(12) Patent Application Publication
(10) Pub. No.: US 2006/0234180 A1
(43) Pub. Date: Oct. 19, 2006

(54) Herbst orthodontic appliance with improved pivot

(75) Inventors: Scott A. Huge, Cumming, GA (US); Arlen J. Hurt, Dacula, GA (US); Terry G. Dischinger, Lake Oswego, OR (US)

Correspondence Address: DORR, CARSON & BIRNEY, P.C.;ONE CHERRY CENTER, 501 SOUTH CHERRY STREET, SUITE 800, DENVER, CO, 80246, US

(73) Assignee: Specialty Appliance Works, Inc.

(21) Appl. No.: 11/404,713

(22) Filed: Apr. 14, 2006

Related U.S. Application Data
(60) Provisional application No. 60/672,466, filed on Apr. 18, 2005.

(51) Int. Cl. A61C 3/00

(52) U.S. Cl. 433/19

(57) ABSTRACT

A pivot for use in a Herbst orthodontic appliance has a base attached to the attachment structure on a patient's tooth, a barrel extending from the base to pass through an eyelet on the end of telescoping members of the Herbst appliance, and a head retaining the eyelet on the barrel. The barrel includes a saddle that allows a range of angular motion for the telescoping members outside of a plane normal to the central axis of the barrel.

### RELATED APPLICATION

The present application is based on, and claims priority to the Applicants' U.S. Provisional Patent Application 60/672,466, entitled “Herbst Orthodontic Appliance With Improved Pivot,” filed on Apr. 18, 2005.

### BACKGROUND OF THE INVENTION

1. Field of the Invention

The present invention relates to improved devices for orthodontic treatment and in particular, improved devices for treatment based on the Herbst orthodontic appliance.

2. Statement of the Problem

The Herbst appliance, and Herbst orthodontic therapy as originally disclosed in 1910 by German orthodontist, Dr. Emil Herbst, have become widely accepted today. FIGS. 1 and 2 show one example of a conventional Herbst orthodontic appliance. The Herbst mechanism spans between the upper posterior teeth and the lower canine region. One common configuration of the Herbst appliance includes a two-part telescoping mechanism 30 consisting of a rod connected to the lower arch 12 and a tube connected to the upper arch 11. The ends of these telescoping segments have eyelets engaging pivots secured to the upper and lower arches 11, 12. As an orthodontic patient closes his or her teeth, the telescoping mechanism 30 slides together until a predetermined limit is reached. Beyond that limit, the telescoping segments exert a force that tends to reposition the mandible forward with respect to the maxilla, and thereby over the duration of treatment, physiological accommodation and a correction of the over-bite condition is achieved. The prior art includes other configurations of the Herbst mechanism and other means of attachment, such as telescoping assembly having three or more segments. However, it is the forward positioning of the mandible accomplished by a telescoping mechanism that characterizes the Herbst appliance.

One common configuration of the Herbst appliance employs pivots having a generally cylindrical barrel 24 that can be brazed, resistance-welded or laser-welded to the appliance structure. Thus, the pivots are fixed relative to the teeth 11, 12. The Herbst structure is typically brazed to molar bands or crowns 20 and sometimes also attached to bands or crowns on bicuspid teeth. A fixed cantilever support arm 22 extending mesially from the molar band or crown 20 can be used as a point of attachment for the lower arch 12. A threaded bolt 26 engages female threads 25 in the end of the pivot barrel 24. Thus, the eyelet 32 of the telescoping member 30 can rotate freely about the pivot barrel, but is retained on the pivot barrel 24 by the bolt 26.

Economic forces drive orthodontic practices to continually strive for ever-increased efficiency. Treatment modalities such as the Herbst appliance that do not depend on patient cooperation and patient compliance meet this requirement. The Herbst appliance does not require periodic patient activation for example, nor are there items to be periodically replaced, such as elastics, as are typically required by other approaches to orthodontic treatment. The Herbst appliance is usually fixed and cannot be altered or deactivated by a patient. The Herbst appliance is capable of achieving a predictable rate of orthopedic and orthodontic correction over a predictable period of time. The more predictable rate of response achieved by the Herbst appliance and Herbst-based treatment in general enables tighter treatment planning and more accurate management of all of the patients being treated by a Herbst-based orthodontic practice.

The Herbst appliance is primarily indicated for Class II correction, which involves the forward re-positioning of the mandible and correction of an undesirable molar relationship associated with what is termed an Angle Class II malocclusion. Of all malocclusions presenting for correction, Class II malocclusions represent roughly 45% of starting orthodontic cases. Another factor that has led to today's widespread acceptance of the Herbst appliance is that generally, the Herbst appliance is associated with philosophies for orthodontic treatment that first emerged in Europe. European orthodontic methods tend to embrace the wider considerations of the musculature and skeletal aspects of treatment. Such an approach contrasts to the narrower orthodontic approach limited to moving the teeth within their alveolar support. The “railroad tracks” metal braces approach evolved mainly in the United States. Today, a synthesis of the European and U.S. approaches has emerged, where modern orthodontists often approach a patient's treatment with an orthopedic first phase and then finish a case with an orthodontic finishing phase. The Herbst appliance performs very well in a first phase role, serving as a central motive engine for correcting the anterior-posterior relationship between the arches. However, many popular adjuncts to conventional Herbst appliance design enable it to also achieve some basic objectives of the finishing phase simultaneously with first phase objectives. For all of these reasons then, the Herbst appliance has become an important part of the delivery of orthodontic care today.

As described, the Herbst appliance, as disclosed originally by Dr. E. Herbst, functions to reposition the mandible to a more forward position. Over time, as the mandible is urged forward, accommodative physiological adaptation occurs in the areas of the cartilaginous tissues of the temporal mandibular joint, the facial musculature and forward-directed growth is encouraged in the mandible itself. All of these desirable changes restore a harmonious relation between the upper and lower arches so that final aesthetic orthodontic positioning of the teeth can be accomplished in an occlusion that is fundamentally in balance and occluding in essentially correct relation.

In spite of the wide acceptance of the Herbst appliance, it is not without its shortcomings and limitations. For example, the Herbst appliance, perhaps more than any other fixed functional appliance involves a highly mechanistic approach. For example, as described above, each right and left side of the Herbst appliance involves an articulating telescoping structure that spans from the upper posterior attachment point to a lower anterior attachment, such lower attachment usually being located at the space between the cuspid and first bicuspid. As such, the attachment configuration requires that the telescoping structure involve a volume of stainless steel exceeding that of most other appliances.

Essentially then, the Herbst appliance functions to deliver forward-driving forces to the mandible, while corresponding backward-directed forces are absorbed by the upper arch. This occurs as the bilateral telescoping segments bottom out just prior to the full closure by the patient. The bottoming out involves a rigid interference of the telescoping members that imparts a direct shear force, which is transferred directly to the upper and lower attachment points and, in particular, the upper and lower pivots. The pivots become foci of these forces, and must be robust to diffuse such destructive forces to the appliance and to the living anatomy without deformation or failure.

Many inventors have brought forth improvements to the basic design introduced by Dr. Herbst. The improvements address the breakage problems typically encountered during Herbst-based orthodontic treatment. For example, U.S. Pat. No. 4,551,095 to Mason discloses an improved upper attachment means utilizing the same proven type of attachments normally employed to support occipital and cervical tractive forces created by “hi-pull” extra-oral headgear, namely the orthodontic buccal tube employing a headgear tube option. Such buccal tubes are typically attached to upper molars by a tooth-encircling stainless steel band. U.S. Pat. No. 6,413,082 to Binder discloses a complex means of attachment intended to reduce binding and breakage. U.S. Pat. No. 4,462,800 to Jones discloses attachment means for Herbst upper and lower components intended to engage conventional archwires. Jones suggests that a loose, flexible attachment means will create a degree of give in the structural system for accommodating otherwise destructive forces, thereby resulting in a reduction of breakage. U.S. Pat. No. 5,183,388 to Kumar discloses yet other means for attaching upper and lower ends of the Herbst telescoping assembly.

It is important to note that conventional Herbst appliances as shown in FIGS. 2 and 3 (as well as the Kumar patent) have a pivot barrel portion with a cylindrical configuration, regardless of the actual attachment means between the barrel and the rest of the appliance. As described above, the central problematic aspect of the Herbst orthodontic appliance is breakage. The standard Herbst appliance, as it is widely used, is configured in a manner that introduces excessive mechanical restriction to the normal lateral range of motion of the mandible due largely to the relationship between its cylindrical pivots 24 and the engaging eyelets 32. Such mechanical restrictions, when they do occur, generate destructive binding forces within the structure of the appliance, which impinge on the pivots and their attachment means. The all too common breakage of the inter-oral Herbst hardware that results from such binding presents immediate challenges to all involved in the patient's treatment.

In response to this problem, U.S. Pat. No. 5,620,321 to Thornburg et. al. discloses a modified ball-and-socket attachment mechanism in place of a cylindrical pivot. Even though a ball and a socket attachment was not new at the time, the configuration of the socket by Thornburg is configured so that the ball is captured by the socket only when the upper tube component and the lower rod component are aligned in a working orientation. Thornburg's invention decreased destructive lateral binding (and therefore breakage) as well as desirably reduced the time and difficulty encountered by an orthodontist when adapting the telescoping appliance components to the upper and lower ball pivots attached to the patient's teeth.

U.S. Pat. No. 6,244,862 to Hanks discloses screw axles with threaded bores supported on the buccal via lingual supports extending up and over the occlusion to the labial or buccal. One of Hank's objectives in the '862 patent is to gain support for the highly-stressed lower screw axles from such structure that spans the occlusion from the lingual to the buccal/labial to reduce stress on the assembly and thereby reduce breakage.

U.S. Pat. No. 5,378,147 (Mihailowitsch), U.S. Pat. Nos. 5,562,445 and 5,738,514 (both to DeVincenzo et al.) and U.S. Pat. No. 5,829,975 (Gold) all describe combinations of three-component telescoping segments and ball-and-socket attachment mechanisms intended to provide improvement over the various problems associated with the Herbst appliance configuration through addressing factors that increase ease of installation, patient comfort, and in particular reduce the tendency toward excessive appliance breakage.

As described above, a ball-and-socket Herbst attachment mechanism has been incorporated into many patented improvements to the Herbst appliance. FIG. 4 shows one example of a ball-and-socket Herbst attachment mechanism 27, 28. One of the advantages described by Hanks for the ball-and-socket attachment mechanism 27, 28 is that the maximum range of freedom for normal left/right mandibular excursions of a patient's jaw is less than the mechanical range that can be freely accommodated by a swiveling ball-and-socket attachment 27, 28. The ball-and-socket arrangement avoids the abrupt, destructive mechanical lock-up that the conventional attachment configuration invites.

The ball-and-socket attachment mechanism has proven to reduce binding and breakage during orthodontic treatment. However, one negative factor associated with the ball-and-socket attachment is that it significantly increases the cost of a Herbst appliance. Manufacturing the very small components, particularly the negative-draft portions of the ball-capturing socket, which involves the step of closing the socket to capture the ball section, from safe, biocompatible materials is challenging and expensive.

3. Solution to the Problem

The present invention addresses the problem of binding and subsequent breakage of conventional Herbst appliances by providing a pivot with a cylindrically concave, curved surface that allows an increase in the range of angular motion of the telescoping segments with respect to the pivots. Pivots configured with such features can be produced at far lower cost than ball-and-socket mechanisms. This approach then provides a range of lateral excursion for the telescoping segments comparable to that of a ball-and-socket attachment mechanism while providing such pivots at a cost comparable to that of a conventional Herbst pivot.

### SUMMARY OF THE INVENTION

This invention provides a Herbst orthodontic appliance having at least one set of telescoping segments extending at a downward angle between the patient's upper and lower teeth. The ends of each set of telescoping segments have eyelets that are attached to pivots secured to the upper and lower teeth. Each pivot has a cylindrically concave, curved surface that allows a significant range of angular motion by the telescoping segments with respect to the pivot.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a perspective view showing an example of a conventional Herbst orthodontic appliance.

FIG. 2 is a exploded view of one set of telescoping members and pivots in a conventional Herbst appliance.

FIG. 3 is a exploded detail view of a pivot and one end of a telescoping member in a conventional Herbst appliance.

FIG. 4 is a detail perspective view of a ball-and-socket attachment mechanism for a Herbst appliance.

FIG. 5 is a perspective view of the pivot in the present invention.

FIG. 6 is a side elevational view of the pivot in the present invention.

FIG. 7 is an exploded perspective view of the right side components of a Herbst appliance with the pivots.

FIG. 8 shows a palatal expansion screw installed within the upper portion of a Herbst appliance.

FIG. 9 is a top elevational view of the rod portion of a telescoping Herbst member attached to a pivot illustrating an example of the range of lateral excursion possible with the present invention.

FIG. 10 is a detail perspective view of a telescoping member and pivot corresponding to FIG. 9.

FIG. 11 is a perspective view of another embodiment of the pivot 40.

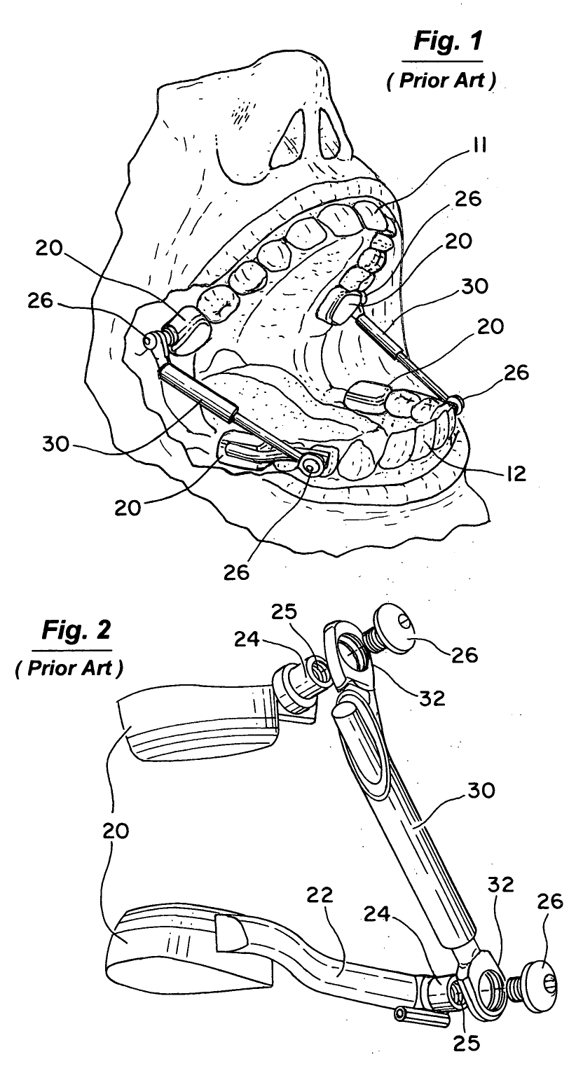

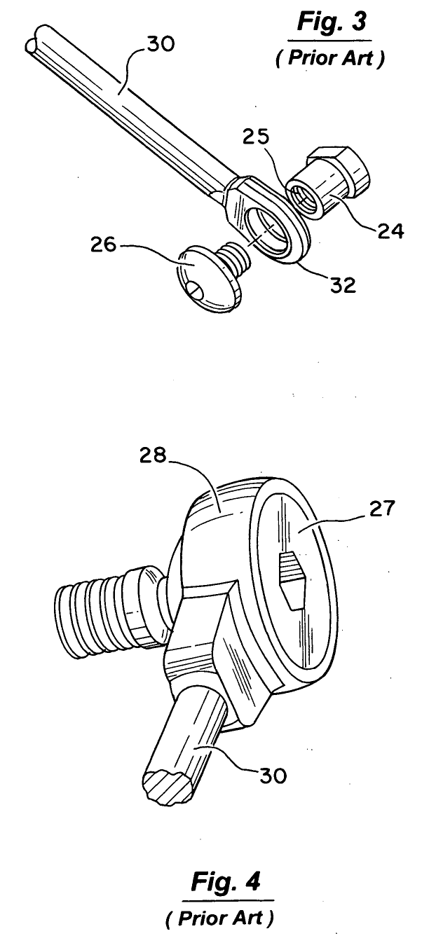

### DETAILED DESCRIPTION OF THE INVENTION

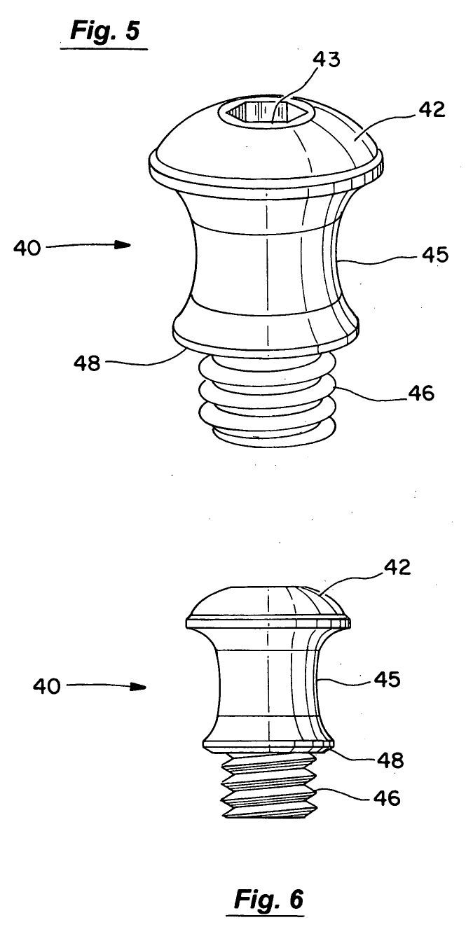

FIGS. 5-7 illustrate a male-threaded Herbst pivot 40 of the present invention. In particular, FIG. 5 is a perspective view of the pivot 40 and FIG. 6 is a corresponding side elevational view. In this embodiment, the pivot 40 includes a head 42 with a recessed socket 43 to engage a tool for tightening and loosening the pivot 40. For example, the recessed socket 43 can be generally hexagonal to receive an Allen wrench. Alternatively the head 42 of the pivot 40 could be equipped with a screwdriver slot, TORX socket, Phillips or Robertson head, or the like. Other types of recesses or head configurations could also be substituted.

The end of the pivot 40 that attaches to the attachment structure 24 fixed adjacent to an upper or lower tooth (depending on which end of the telescoping members 30 is involved) can be referred to as the base of the pivot 40. In the embodiment of the pivot 40 shown in FIGS. 5 and 6, has a base with male threads 46 to engage complementary female threads 25 on the attachment structure 24.

The barrel of the pivot 40 extends from the base to the head 42 of the pivot 40. The barrel has dimensions selected to allow the barrel to pass through the eyelet 32 on the end of the telescoping members 30, and to allow the eyelet 32 to freely rotate about the longitudinal axis of the pivot barrel. At least a portion of the barrel of the pivot 40 has an “apple core” shape, or saddle 45, as is shown most clearly in FIGS. 5 and 6. This saddle 45 has reduced radial dimensions forming a generally cylindrically concave, curved surface that complements the opening in the eyelet 32 on the end of the telescoping members 30. This allows a range of angular motion by the eyelet 32 and telescoping members 30 outside of a plane normal to the central axis of the barrel. Alternatively, the saddle 45 could be described as being radially concave, or having inwardly converging arcuate sides. Preferably, the saddle 45 has a shape that could be described as a conic section or conic hyperbola shape that provides a constant curving saddle for the telescoping segments 30. Alternatively, the saddle's shape in profile could be circular, blended radii, elliptical, or constructed from a free-form swept spline.

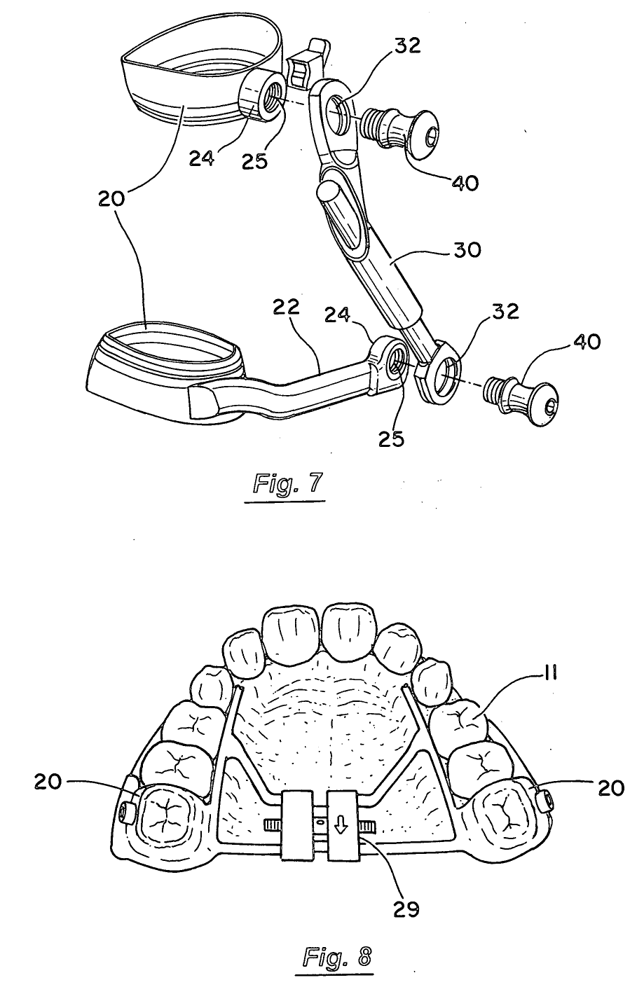

FIG. 7 is an exploded perspective view of one form of a Herbst appliance employing the present pivot 40. The base end of the pivot 40 has male threads 46 that removably engage a corresponding female-threaded attachment structure 24 attached adjacent to the patient's tooth. The female attachment point 24 is typically brazed, resistance-welded or laser-welded to the appliance structure (e.g., a molar band or crown) and as such is fixed relative to the tooth. However, it should be understood that other types of attachment structures could be used to provide a fixed point of attachment for the pivot 40 to the patient's dental anatomy.

To allow assembly of the Herbst appliance, the outside diameters of the saddle 45 and base are smaller than the inside diameter of the eyelet 32 at the end of the telescoping members 30. Thus, the saddle 45, threads 46 and the lower chamfered shoulder 48 of the pivot 40 can be freely inserted through the eyelet 32 at the end of a telescoping member 30. However, the eyelet 32 is retained by the restrictive head 42 of the pivot 40.

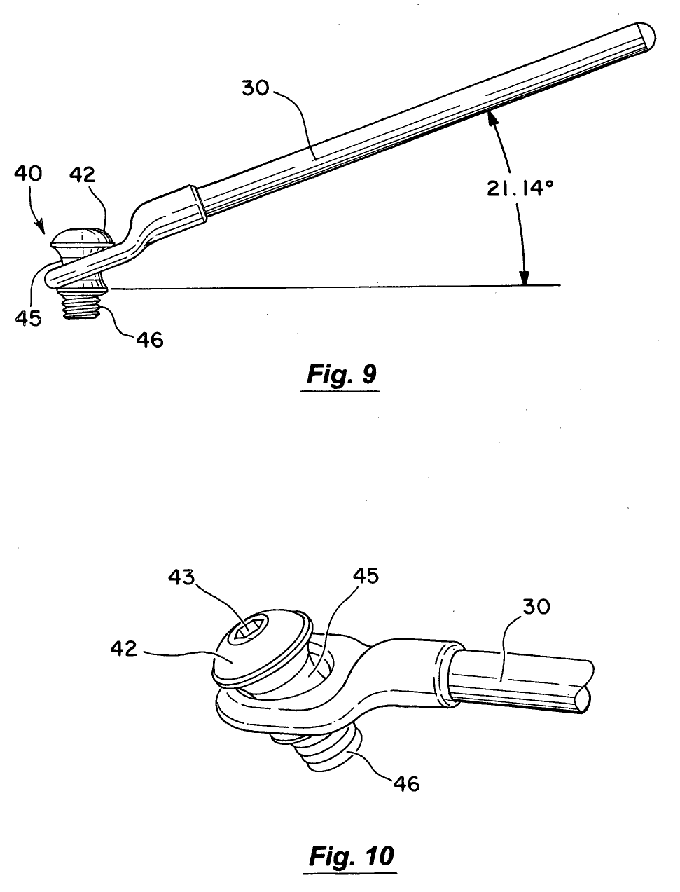

The saddle 45 allows a significantly greater lateral or angular deflection of the telescoping members 30 compared to prior art pivots, as illustrated in FIGS. 9 and 10. FIG. 9 is a top elevational view of a telescoping member attached to a pivot illustrating an example of the range of lateral excursion possible with the present invention. FIG. 10 is a detail perspective view of a telescoping member and pivot corresponding to FIG. 9.

This embodiment of the present invention offers a number of other advantages over the prior art. The lower pivot in particular, being at the cuspid region of the arch, extends outward against the inside surface of the cheeks with some pressure. Any factor that tends to reduce the size or prominence of the outwardly-projecting structure is desirable from the stand point of patient comfort. In the present invention, the ratio of the overall barrel length to the usable barrel length is better optimized than the prior art screw pivots, thereby reducing prominence and enhancing patient comfort.

With conventional Herbst pivots, the stress concentration associated with the hex socket 43 in the head of pivot allows the head of the pivot to be sheared off if over-tightened. In contrast, the curved saddle 45 under the head in the present invention provides more structure for dissipating such stress and thereby avoids creating a region of stress concentration. This configuration also allows the hexagonal socket 43 to be inset desirably deeper into the head 42 without increasing the potential for shearing off the head 42 if over-tightened, which allows the overall labial-extending height of the screw to be reduced. Thus, the profile of the head 42 can be significantly lower, which also greatly enhances patient comfort.

Optionally, a lower chamfered shoulder 48 can be formed between the threads 46 and the barrel of the pivot 40, as shown in FIG. 7. The pivot threads 46 merge toward the saddle section in a chamfered shoulder 48 (e.g., an included angle of about 120 degrees) to abut a corresponding chamfer of the female attachment structure 25. This chamfer helps to reduce stress concentration near the base of the threads, further dispersing potentially destructive forces on the assembly.

Another advantage of the male-threaded pivot configuration is that it allows the entire structure of the pivot to be removed and installed only when needed according to the treatment plan. In contrast, one of the disadvantages of the prior art is that the pivot barrel 24 (see FIG. 2) projects outward against the soft tissue in the patient's mouth even during periods when the telescoping members 30 are not attached to the Herbst appliance. During treatment, the structure of a Herbst appliance may be adapted and placed in a patient's mouth weeks or months before the Class II malocclusion-correction phase begins. For example, as seen in FIG. 8, the Herbst appliance may incorporate other devices addressing other generally unrelated treatment functions such as palatal expansion. In FIG. 8 a palatal expansion screw 28 is shown integrally installed within the upper portion of a Herbst appliance. For the period of time that the palatal expansion objectives are being accomplished prior to installing the telescoping mechanisms, the presence of the conventional Herbst pivots in position in the patient's mouth can be very uncomfortable due to their protrusion outward against the inside of the cheeks and lips. In contrast, the present invention has no protrusive structure at all until the pivot is installed.

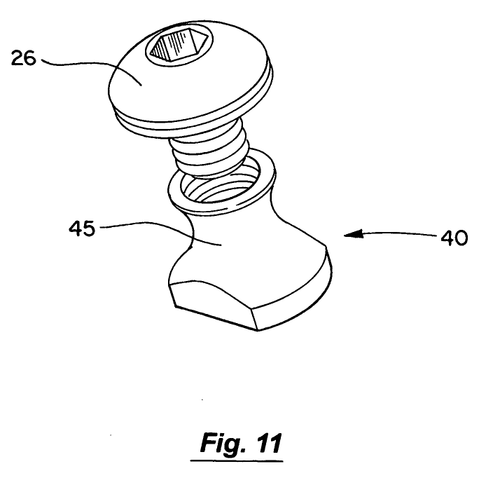

FIG. 11 is a perspective view of another embodiment of the pivot. In this embodiment, the base of the pivot 40 is fixed to the remainder of the appliance structure, similar to the prior art pivot shown in FIG. 2. For example, the base of pivot 40 can be welded to the attachment structure or fabricated as part of the attachment structure. The outwardly-extending labial end of the pivot 40 includes female threads to removably engage a threaded bolt 26, which forms the retentive head 42 of the pivot, when in place. Unlike the prior art pivot in FIG. 2, the pivot barrel 40 includes a saddle 45 that allows a substantial range of angular motion by the telescoping members 30. Alternatively, the labial end of the pivot 40 could have male threads that removably engage female threads on the head 42 (e.g., the head could be a nut).

A second, female-threaded embodiment is also possible. In this embodiment, the base of the pivot has female threads that engage corresponding male threads protruding from the appliance structure. It should be expressly understood that other types of attachments could be substituted for threads in each of these embodiments.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A pivot for use in a Herbst orthodontic appliance having telescoping members extending between attachment structures on a patient's upper and lower teeth with an eyelet on at least one end, said pivot comprising:
a base attached to an attachment structure;
a barrel extending from the base to pass through an eyelet, and having a saddle allowing a range of angular motion for the telescoping members outside of a plane normal to the central axis of the barrel; and
a head retaining the eyelet on the barrel.

2. The pivot of claim 1 wherein the base further comprises threads for engaging complementary threads on the attachment structure.

3. The pivot of claim 2 further comprising a chamfered shoulder between the threads and barrel.

4. The pivot of claim 2 wherein the head further comprises a socket.

5. The pivot of claim 1 wherein the saddle comprises a cylindrically concave curved surface.

6. The pivot of claim 1 wherein the saddle comprises a radially concave surface.

7. The pivot of claim 1 wherein the saddle comprises inwardly converging arcuate sides.

8. The pivot of claim 1 wherein the head further comprises threads for engaging complementary threads on the labial end of the barrel.

9. A pivot for use in a Herbst orthodontic appliance having telescoping members extending between attachment structures on a patient's upper and lower teeth with an eyelet on at least one end, said pivot comprising:
a base with threads to removably engage complementary threads on an attachment structure, said base having dimensions to pass through an eyelet;
a barrel extending from the base to pass through the eyelet, and having a saddle allowing a range of angular motion for the telescoping members outside of a plane normal to the central axis of the barrel; and
a head retaining the eyelet on the barrel.

10. The pivot of claim 9 further comprising a chamfered shoulder between the threads and barrel.

11. The pivot of claim 9 wherein the head further comprises a socket.

12. The pivot of claim 9 wherein the saddle comprises a cylindrically concave curved surface.

13. The pivot of claim 9 wherein the saddle comprises a radially concave surface.

14. The pivot of claim 9 wherein the saddle comprises inwardly converging arcuate sides.

15. A pivot for use in a Herbst orthodontic appliance having telescoping members extending between attachment structures on a patient's upper and lower teeth with an eyelet on at least one end, said pivot comprising:
a base attached to an attachment structure;
a barrel extending from the base to pass through an eyelet, said barrel having:
(a) a saddle allowing a range of angular motion for the telescoping members outside of a plane normal to the central axis of the barrel; and
(b) a labial end with threads; and
a head having threads to removably engage the threads on the barrel, said head having dimensions to retain the eyelet on the barrel.

16. The pivot of claim 15 wherein the saddle comprises a cylindrically concave curved surface.

17. The pivot of claim 15 wherein the saddle comprises a radially concave surface.

18. The pivot of claim 15 wherein the saddle comprises inwardly converging arcuate sides.

19. The pivot of claim 15 wherein the head further comprises a socket.
